(19) United States
(12) Patent Application Publication
(10) Pub. No.: US 2007/0275168 A1
(43) Pub. Date: Nov. 29, 2007

(54) Manufacturing of Photocatalytic, Antibacterial, Selfcleaning and Optically Non-Interfering Sufaces on Tiles and Glazed Ceramic Products

(76) Inventor: Jan Prochazka, Zehrovice (CZ)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/571,981

(22) PCT Filed: Mar. 13, 2003
(86) PCT No.: PCT/CZ03/00019

§ 371 Date: Apr. 4, 2007

(51) Int. Cl. C04B 41/87

(52) U.S. Cl. 427/314

(57) ABSTRACT

The principle of the deposition technique uses ultrafine crystals of ceramic oxides deposited relatively cold on melted or partially melted surfaces of ceramic tiles and other glazed ceramics, creating a spotty deposition without a significant change of optical properties of the surface. Because the desired nano-substance is deposited cold in a solid state form on the hot “sticky” surfaces and rapidly cooled down, deposited material is directly melted into the substrate surface, but its outer side remains unchanged. It allows creating a deposition with the desired parameters, for amplifying and extending the antibacterial protection in the dark, these surfaces may contain noble and heavy metals, deposited either dry as a part of the powder, or in a separate step, directly on the surface by wet depostion followed by drying and calcination.

### TECHNICAL FIELD

The present invention is related to manufacturing of photocatalytic, antibacterial, self-cleaning and sanitizing surfaces on ceramic tiles and other ceramics. The technique is creating a thin spotty deposition of TiO₂ and other active ceramic materials, or their mixtures consisting of ultrafine crystals on the surface of glazed ceramic products (further Deposition).

### BACKGROUND OF THE INVENTION

Considerable scientific and industrial effort has been spent on creating a photocatalytic, antibacterial, sanitizing and self-cleaning ceramic tiles, bath tubs, toilet dishes and other sanitary ceramic products, while the optical properties such as gloss, color and good mechanical properties of the product surface are preserved.

The hottest candidates able to carry the task are TiO₂ and ZnO ceramic oxides, which often have to be nano-sized and doped to be fully functional in this application.

Several methods have been used to obtain a thin and transparent layer of a photocatalytic material such as nano anatase, a crystal form of TiO₂ on ceramic surfaces. However, cost, environmental issues and major technical difficulties were always associated with the preparation. Mechanical and optical properties of layers made by these techniques were not always satisfactory.

CVD methods are often used because the anatase layer is tightly attached to the glass and ceramic surfaces. However, using of TiCl₄, organometalic and organic compounds represents certain ecological risks. Chemical Vapor Deposition also cannot be used at very high temperatures because phase unstable anatase would undergo rutile phase transformation. It may also chemically react with some substrates, containing kations from first and second group of periodic table.

Sol-gel methods have been used often to deposit thin, optically transparent films onto glass and ceramics by hydrolysis of Titanium organometalic compounds followed by calcination at 400-600° C. The films produced by this method show good transparency and photocatalytic characteristics, but do not have a very good mechanical resistance against moisture and abrasion. The layer consist of small anatase crystals sintered in a mesoporous structure and causes strong optical interference on the surface.

Flame and Plasma sprayed TiO₂ layers are accompanied by phase changes and minimally a partial conversion of anatase into rutile crystal phase. These layers have good mechanical and abrasion properties, but they cannot be optically transparent and primary particles grow significantly during this high temperature deposition, lowering photocatalytic activity and properties associated with it. Porosity of these layers is another issue affecting the product quality.

Some industrial products are based on calcination of anatase mixed into silica gel and other binders. Even when no chemical reaction of anatase and the binder occurs, the anatase particles get encapsulated in the binder and the layer does not function the same as the anatase crystal surface. Silica coating has been used by TiO₂ pigment producers to block fotocatalytic activity of TiO₂ particles for decades.

Sputtering methods are not suitable for low cost products and mass production of large quantities. The control of TiO₂ crystal form and the layer density is another challenging problem for sputtering methods.

Japanese company TOTO Ltd. possesses number of patents describing general principle of manufacturing of ceramic tiles and other products with “Hydrotect” layer finishing. In this patented technology nanosized anatase is mixed into SiO₂ colloidal suspension with other inorganic compounds, sprayed wet on the surface of an already glazed tile and calcined till the top layer is firmly joint to the tile glaze. TOTO patents claim that TiO₂ exist as TiO₂ even after the calcination step, however, the TiO₂ photocatalytic activity is likely eliminated by the silica environment.

Most attempts to put titanium dioxide in the anatase form directly in glazes to obtain photocatalytic surface failed because of chemical reaction during calcinations, encapsulation of the TiO2 and other negative effects such as increasing the glaze melting point. Even if the high calcination temperature and presence of alkali metal ions does not change chemical composition, it often converts anatase TiO₂ form into rutile, or the particle size grows too big to be highly photocatalytic.

All technologies attempting to deposit phase unstable anatase crystal form on ceramic surfaces at high temperatures are facing difficulties such as particle size growth and phase transformation reducing photocatalytic activity and causing change in optical properties, or a chemical reaction eliminating completely the photocatalytic activity. A layer structures on the surface are either causing optical interference or the surface cannot have high gloss. Good adhesion of the top layer to the substrate surface may also be a problem.

Therefore, there is a need for an economical, large scale, high temperature process, which can make a strong deposition of ceramic compounds such as anatase in a desired crystal form, preferably with a high surface area, on the top of the substrate and directly exposed to the surface.

### SUMMARY OF THE INVENTION

The present invention provides an economical process for a production of surface treated ceramic products, with photocatalytic, antibacterial, self-cleaning and sanitizing features, without significant changes of the surface optical properties. The process is based on “cold” deposition of ultrafine ceramic powders, directly on melted and partially melted, ceramic surfaces. Many ceramic glazes are kinetic products, chemically reacting under the transformation temperature point, also providing good conditions (“sticky” surface) for nano-ceramic powder deposition described in this invention.

The deposition of aggregates, agglomerates, or micronized products of a significantly colder fine powder of ceramic compounds preferably occurs in the furnace heat zone, just before the cooling cycle, but it is not a limitation for most of the ceramics. The powder melts into the surface, undergoing partial sintering, creating a deposition, with desired chemical, optical, physical and mechanical properties after cleaning. The material, which is not bonded to the surface, is easy to remove after cooling. Removal of the excess of used material, leaving just the bottom layer, directly attached to the ceramic product surface, opens a clean surface of nanoparticles of deposited material. This thin deposition usually does not significantly interfere with optical properties of the product, such as color or gloss, because it is a spotty deposition not a compact interferential layer. The deposition optimally makes shallow impacts less than 1 μm in size, which still does not reduce high gloss of the surface. The impact spot is covered by nanoparticles of anatase or other ceramic compound, which are too small to scatter light and change the look of the surface (FIG. 5).

The size of the powder agglomerates or aggregates used in this process is preferably small. Optimal grain size of the agglomerated powder, consisting of small primary particles, is under 100 μm, and not much less than 1 μm.

The character of the deposition guaranties that the chemical composition of the surface is changed proportionally to the area, covered by the ceramic powder. One side of the powder particle is melted into the surface, while the outer side of the powder is always pure compound. This effect guarantees that the final layer is always the same as the powder side. The final layer of any spot hit by the powder has a chemical composition of the powder, and its crystal structure and morphology.

The nano-ceramic powder deposition on the melted ceramic surface of the substrate followed by rapid cooling reduces high temperature exposition of the powder to the minimum. It allows phase unstable anatase crystals to survive, reduce particle size growth and stop a chemical reaction in early stages.

The ceramics for the deposition can be photocatalytic and antibacterial compounds such as TiO₂-anatase and ZnO, heavy and noble metal doped nano-ceramic powders and mixtures thereof. Antibacterial agents such as silver can be deposited on the ceramic product surface either as a part of the powder or in an additional treatment of the surface followed by a calcination step.

### DESCRIPTION OF THE DRAWINGS

FIG. 1. is a general flow sheet, showing the steps of one embodiment of the process of the present invention, where the powder deposition is provided by a nozzle system or in a “dust chamber”.

Step 1. is a container for storage of the cold feed powder material. Typically, spray dried agglomerates, aggregated materials or micronized products of nano anatase in pure or doped form are used. The agglomerates may contain antibacterial agents such as silver deposited on nano anatase surface also increasing anatase photocatalytic activity. Other doping increasing phase or thermal stability can also be used.

The feed powder is then sprayed through air or water cooled nozzles and the powder surrounded by “cold” air hit the surface of a melted or partially melted ceramic surface in the “dust chamber” (step 2). He substrate can have an irregular shape. As soon as the powder particles are melted into the glaze on the substrate surface, the surface is immediately cooled down to a safe temperature, to avoid particle size growth, phase change and a chemical reaction (step 3). Depending on the substrate and glaze used for the Deposition, sometimes several cooling steps may be required. Typically the first ramp down step is around 800° C. When a gentle cooling by a slow air draft, lowering the surface temperature is applied (step 8), it is quite easy to hold the surface temperature in the range, where no cracking, particle size growth or phase transformation occurs. Thermal exposition of the powder particles should be as short as possible, for the same reasons. The hot powder is rapidly discharged and cooled in step 4. Materials used for the deposition modify the product surface, giving it special properties, which the material possesses itself, such as photocatalytic activity, antibacterial functioning, self cleaning properties, etc. In contrast to layers created on the surface by other techniques, the unique spotty deposition described in this invention does not have any significant optical interference effects and practically does not unintentionally change the optical quality of the product surface. Another aspect of this invention is that properties of the final ceramic surface are a combination of characteristics of the substrate and the deposited material and can be adjusted (Step 5). The deposited layer on the surface can go through simple cleaning, or it can be further modified. For example a wet deposition of Ag salt can be dry on the surface and calcined (step 6). Final product than is a photocatalytic and antibacterial tile or ceramic product, which can be selfcleaning and generally looks the same as the surface before deposition (step 7).

FIG. 2. Is a flow sheet of another embodiment of the process of the present invention, where the powder deposition created by discharging the substrate directly into cold powder of the ceramic compound.

FIG. 3. Graphical description of the deposition from an optical and mechanical quality point of view.
a) A deposition of nano anatase with bad properties-powder particles sunk too deep into the described layer, lost contact with the surface and worsened optical and mechanical properties of the surface.
b) Good deposition resulting in good optical and mechanical properties of the final surface.
c) Excellent shallow deposition. A surface with excellent optical and mechanical properties, after cleaning.

FIG. 4. Describes the surface after the deposition and before and after cleaning.
a) The surface after deposition—the ceramic compound powder particle is melted into the surface.
b) The surface after removing anything that is not firmly attached to the surface, leaving a thin, spotty deposition of small primary crystals or their aggregates, which is changing the surface properties and chemical composition. After deposition the new ceramic is covering the surface up to 90%.
c) Top section of the picture a) and b).

FIG. 5. is a scanning electron microscope image of a ceramic tile, with a permanent deposition of about 40% of nano anatase on the surface.

FIG. 6. is a scanning electron microscope image of a ceramic tile, with a permanent deposition of about 80% of nano anatase on the surface.

The following examples illustrate, but do not limit, the present invention.

### EXAMPLE I

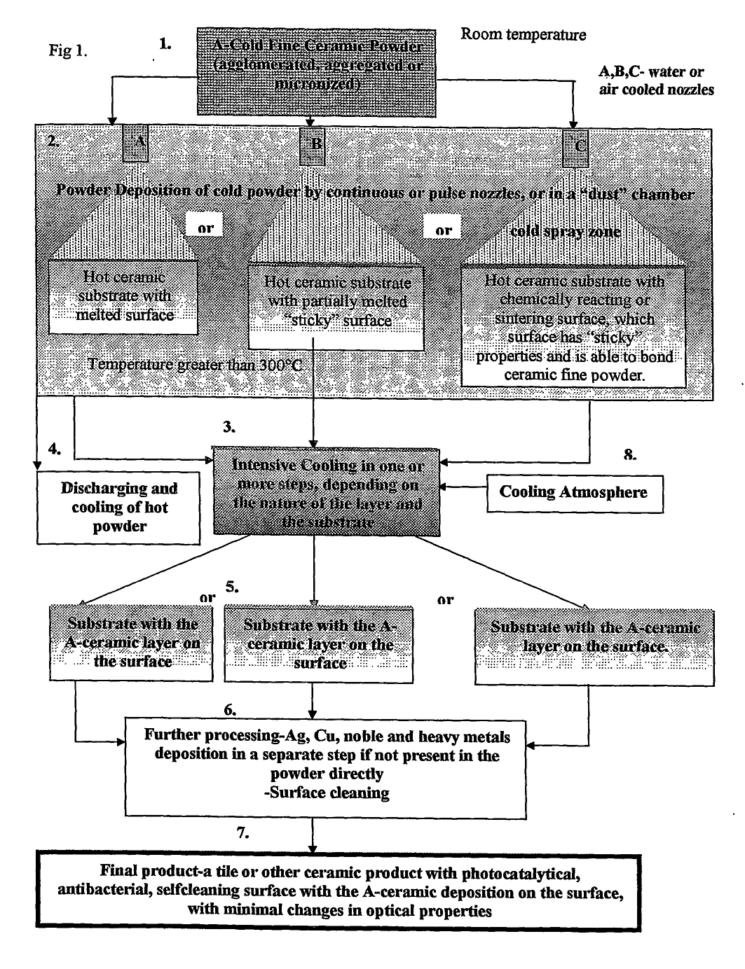

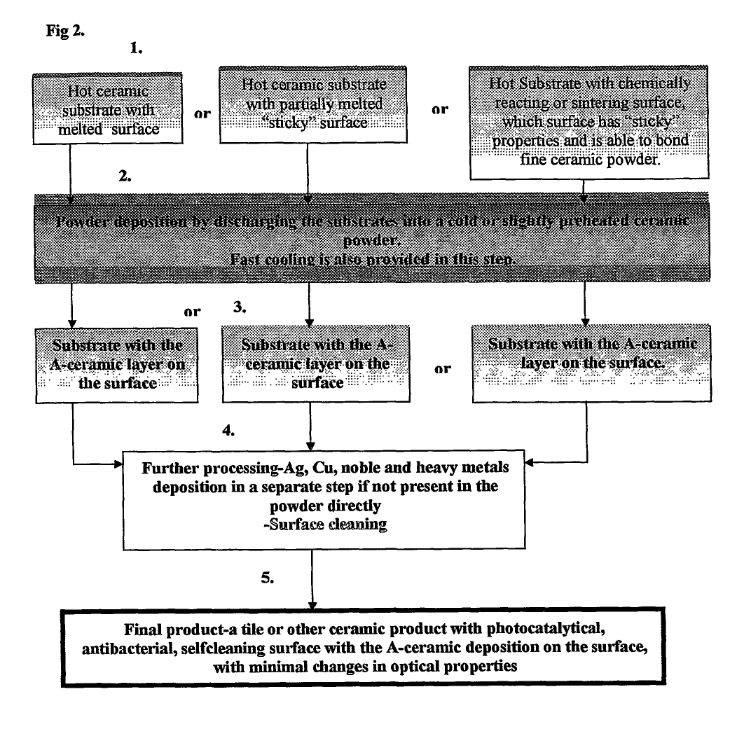

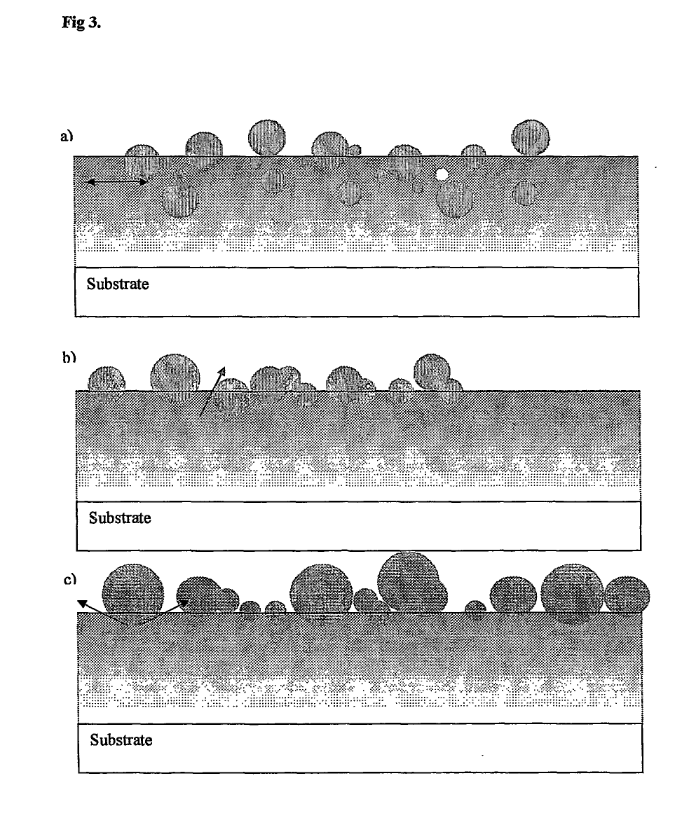

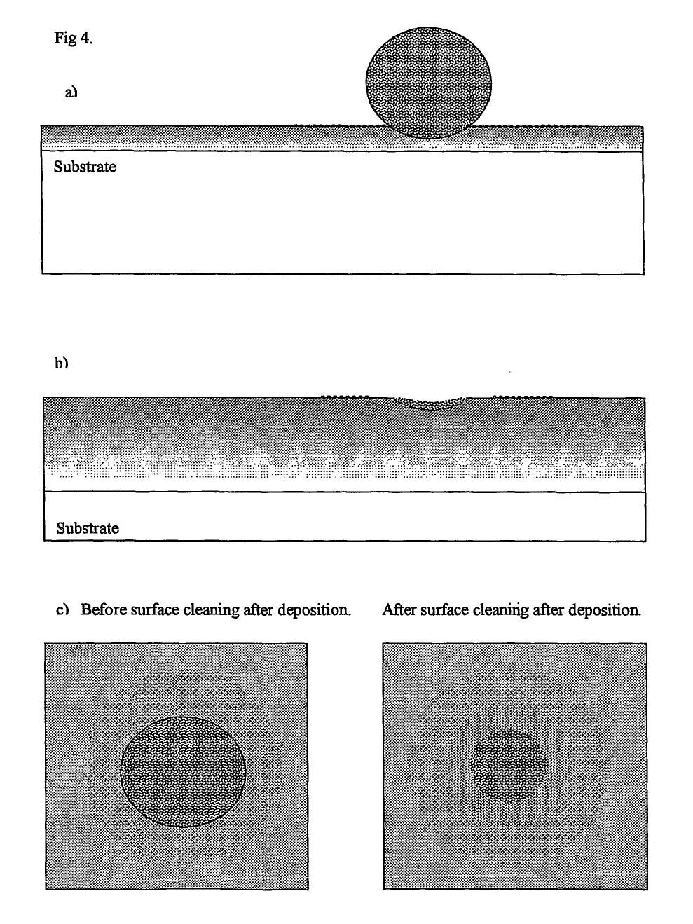

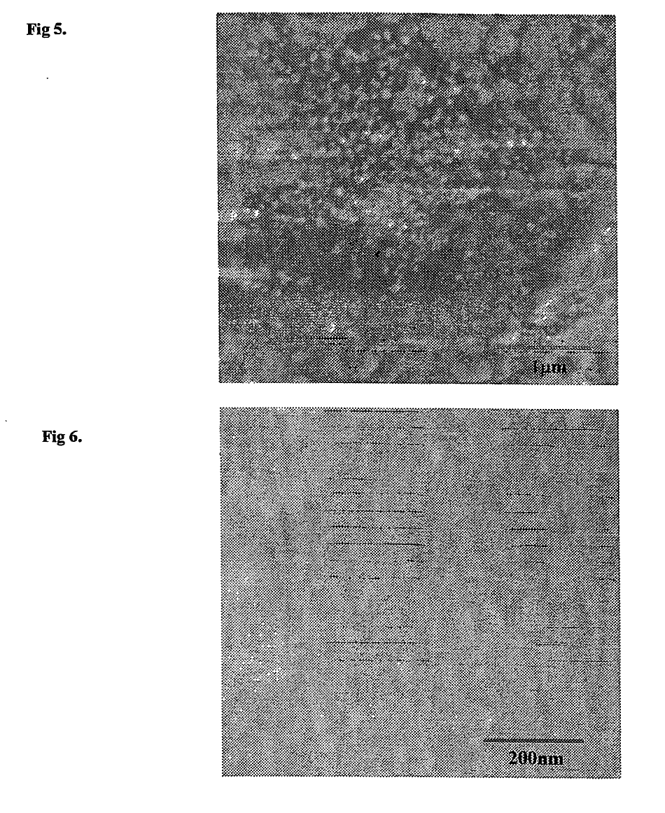

A layer of several types of commercial ceramic tiles was horizontally placed on a removable holder in a muffle furnace. The tiles all had glossy finish but different colors. The surface of each tile was cleaned with water and isopropanol before calcination. No exact transformation temperature and melting point of the glaze materials were known. The furnace temperature was set on 1100° C. It reached the temperature in about 90 minutes and was held for another 15 minutes. Then, the furnace was opened and within 5-10 seconds about 0.5 g of nano-sized anatase in a form of fine, cold powder was blown into the furnace, using a simple pipe quartz nozzle. Air circulation of the powder was allowed for another minute, while the furnace was rapidly cooling down. Then the holder with the tiles was removed from the furnace and let cool down to the room temperature in an open air (FIG. 1).

The tile surfaces were washed in DI water, dried and analyzed. None of the surfaces lost its gloss and except for one type of tile, they did not change the original appearance. The experiment with this type of tiles was repeated at 1020° C. because in the previous experiment the glaze on the tile surface was obviously too thin during the 1100° C. exposition and the powder agglomerates penetrated too deep into the glaze, affecting so the appearance of the surface (FIG. 3). Very similar results and hole free surface were obtained with the particular type of tiles after lowering the deposition temperature.

In other experiments, very fast air cooling was provided to the tiles, to make the nano-anatase exposition to the high temperature as short as possible to reduce possible particle size growth and phase transformation into rutile. Sometimes the cooling was bringing temperature of the tile surface under 500° C. within seconds, but too fast cooling was often accompanied by tile cracking.

All the surfaces were strongly photocatalytic by the 1% AgNO3 test. FE-SEM analysis indicated that total about 15-20% of the surface was directly covered by a thin nano anatase deposition. Generally, up to 90% of the glaze surface can be covered by this deposition technique, using micronized powders. High magnification imaging determined minimal changes in size of the nano crystals of anatase and their deposition directly on the top of the tile glaze. One side of the nanocrystals was melted into the glaze, the other side was exposed to the air. Mechanical properties of the treated surfaces did not change noticeably. When these treated surfaces were fresh, they showed superhydrofilic properties, which however rather quickly vanished. Two hour exposition to UV light brought the superhydrofillicity back.

### EXAMPLE 2

A set of the same commercial tiles as in the EXAMPLE 1 was ramped to 1050° C. and then directly discharged into Ag-surface treated nano-anatase cold fine powder (FIG. 2). After washing and drying, high gloss surfaces were obtained (FIGS. 3 and 4). Separate set of clean tiles treated as in the Example 1 was used for AgNO3 surface post-treatment after anatase deposition. AgNO3 solution (0.03%) was sprayed on the warm anatase treated tile surface, and calcined at 500° C. after drying. Both experimental sets produced photocatalytic sanitizing surface.

### EXAMPLE 3

Several tiles of a commercial product Hydrotect were heated to 1100° C. in a furnace. Then Ag surface treated nano anatase cold powder was deposited on the surface by a simple quartz nozzle air blow of the powder. The tiles on the surface were cooled during this deposition to about 800° C. and then removed from the furnace. Antibacterial, photocatalytic tile surface was obtained, while most of the original properties of this product were preserved. The product did not change its look and still remained hydrophilic.

### EXAMPLE 4

An irregular shape piece of a porcelain ceramic plate was slowly heated in the furnace to the point, when the surface became “sticky”. It was not clear, if the surface layer melted, or partially melted, as the ramping to 1200° C. was taking place. Immediately after the temperature reached 1200° C., the furnace was opened and at temperature 1150° C. a cold nano anatase powder was puffed on the surface by two “cold” air nozzles and the porcelain surface quickly but gently cooled in blowing air. A high gloss, photocatalytic surface was obtained.

### EXAMPLE 5

A mixture of ZnO and anatase nanoparticles was deposited as cold powder by the technique described in EXAMPLE 1 at 1050° C. on a ceramic tile. Before cleaning the surface, a diluted mixture (0.03%) of Ag and Cu nitrates was sprayed on the tile surface and calcined at 550° C. After cleaning this sanitary tile, a surface consisting of a spotty deposition of photocatalytic, self cleaning nano anatase and ZnO surrounded by a glaze with functional antibacterial surface was obtained.

What is claimed is:

1. A novel process for manufacturing of photocatalytic, antibacterial, self-cleaning and sanitizing surfaces on ceramic tiles and other ceramic products comprising:
a) creating a sticky surface on ceramic tiles or glazed ceramic products by heating;
b) depositing an active photocatalytic and antibacterial ceramic compound in a powder form on the sticky surface;
c) exposing and bonding the powder to the sticky surface;
d) rapidly cooling the surface with the powder deposition to temperatures under 850° C.;
e) cooling the product to the room temperature.

2. A process of claim 1, further comprising removing the unbonded powder from the glazed surface.

3. A process of claim 1, wherein the powder of the active ceramic compound is selected from a group of photocatalytic and antibacterial compounds consisting of metal oxides.

4. A process of claim 3, wherein the metal oxide is TiO₂, ZnO, CuO, Ag₂O, SnO₂ and mixtures thereof.

5. A process of claim 4, wherein the powder of the active ceramic compound is TiO₂ crystal form of undoped or doped anatase, with the average particle size smaller than 100 nm.

6. A process of claim 4, wherein the powder for Deposition is doped or undoped TiO₂ crystal form of rutile with the average particle size smaller than 500 nm.

7. A process of claim 4, wherein the powder for Deposition is doped or undoped ZnO, with the average particle size smaller than 1 μm.

8. A process of claim 1b), wherein the powder is colder than the sticky surface.

9. A process of claim 1a), 1b) and 1c) wherein the sticky surface for powder deposition is melted, partially melted or chemically reacting and it is able to bond the solid phase ceramic compound used for the Deposition.

10. A process of claim 1d), wherein cooling is fast enough to prevent chemical and physical changes of the chemical composition, crystal phase and particle size of the deposited compound.

11. A process of claim 1, wherein the spotty deposition of the powder of the active ceramic compound covers up to 90% of the glazed surface.

12. A process of claim 10, wherein gloss and other optical properties of the product are not significantly changed by the Deposition.

13. A process of claim 1, wherein the excess of the powder of the active compound does not significantly change its own chemical composition, crystal phase, morphology and particle size during the Deposition and can be recycled.

14. A process of claim 1 further comprising doping the surface with heavy and noble metals possessing antibacterial character and extending the antibacterial properties of the product.

15. A process of claim 14, wherein the metals are selected from the group consisting of silver, copper, zinc and platinum.

16. A process of claim 14, wherein the metals are introduced as a part of the dry powder described in claim 1.

17. A process of claim 14 comprising doping the surface with noble and heavy metals by depositing water soluble salts on the surface received in claim 1e), followed by drying and short calcination at a temperature between about 300° C. and about 900° C.
